(19) United States
(12) Patent Application Publication
(10) Pub. No.: US 2022/0249215 A1
(43) Pub. Date: Aug. 11, 2022

(54) CURING LIGHT WITH ROTATIONAL BEARING

(71) Applicant: CAO Group, Inc., West Jordan, UT (US)

(72) Inventors: Zihou ZHANG, West Jordan, UT (US); Zhaohui LIN, Salt Lake City, UT (US)

(73) Assignee: CAO Group, Inc., West Jordan, UT (US)

(21) Appl. No.: 17/668,217

(22) Filed: Feb. 9, 2022

Related U.S. Application Data
(60) Provisional application No. 63/147,722, filed on Feb. 9, 2021.

(51) Int. Cl. A61C 13/15

(52) U.S. Cl. CPC A61C 19/004

(57) ABSTRACT

A bearing for use with curing lights provides a secure mounting structure for curing light emitter heads while allowing rotation of the same about an axis defined by the curing light handpiece and its connection structure. The bearing allows for the curing light emitter head to rotate fully about the axis while allowing light to pass therethrough for the purpose of curing materials during a procedure.

### CROSS-REFERENCES TO RELATED APPLICATIONS

The Present application claims priority as a non-provisional perfection of U.S. Application No. 63/147,722, filed Feb. 9, 2021, and incorporates the same by reference herein in its entirety.

### FILED OF THE APPLICATION

The present invention relates to the field of medicine and dentistry and more particularly relates to a curing light, used in various procedures, with a fully rotatable emitter head enabled by a bearing.

### BACKGROUND OF THE INVENTION

Curing lights have become an indispensable tool in modern dentistry. The emitter heads of curing light handpieces are fixed in a single orientation with respect to the handpiece. Yet a rotating emitter head would more efficiently allow curing of materials in different positioned within the oral cavity. Most curing light emitter heads are self-contained, featuring a housing and a light conduit, and attach to a handpiece, which provides the light for direction by the emitter head. With an appropriate bearing, a curing light emitter head may be made fully rotatable about an axis defined by the handpiece. The present invention is a curing light that utilizes a bearing structure that allows for full rotation of the curing light emitter head about the handpiece on a defined axis. The present invention represents a departure from the prior art in that the bearing of the present invention allows for simple, effective, and full rotation of the curing light emitter head about the handpiece of the curing light.

### SUMMARY OF THE INVENTION

In view of the foregoing disadvantages inherent in the known types of curing lights, an improved curing light may provide a bearing at the interface of the curing light emitter head and curing light handpiece that meets the following objectives: that it allows full rotation of the emitter head about an axis defined by the handpiece, that it be durable and made from materials that may be readily sterilized, that it be reusable as a part of the handpiece, that it be cost effective and simply manufactured and implemented. As such, a new and improved curing light bearing may comprise a bearing sleeve rotatably positioned on a mount, with the sleeve being the primary contact between the curing light emitter head and the handpiece to accomplish these objectives.

The more prominent features of the invention have thus been outlined in order that the more detailed description that follows may be better understood and in order that the present contribution to the art may better be appreciated. Additional features of the invention will be described hereinafter and will form the subject matter of the claims that follow.

Many objects of this invention will appear from the following description and appended claims, reference being made to the accompanying drawings forming a part of this specification wherein like reference characters designate corresponding parts in the several views.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in many ways. Also, it is to be understood that the phraseology and terminology employed herein are for description and should not be regarded as limiting.

As such, those skilled in the art will appreciate that the conception, upon which this disclosure is based, may readily be utilized as a basis for the designing of other structures, methods, and systems for carrying out the several purposes of the present invention. It is important, therefore, that the claims be regarded as including such equivalent constructions as far as they do not depart from the spirit and scope of the present invention.

### BRIEF DESCRIPTION OF THE DRAWINGS

To describe the manner the above-recited and other advantages and features of the invention can be obtained, a more particular description of the invention briefly described above will be rendered by reference to specific example embodiments thereof which are illustrated in the appended drawings. Understanding that these drawings depict only typical embodiments of the invention and are therefore not to be considered as limiting of its scope, the invention will be described and explained with additional specificity and detail using the accompanying drawings.

FIG. 1 is a top plan view of a curing light.

FIG. 2 is a perspective view of a bearing for use in the curing light of FIG. 1.

FIG. 3 is an exploded view of the bearing of FIG. 2.

FIG. 4 is a sectional view of the bearing of FIG. 2, with a curing light emitter head (partial) attached.

FIG. 5 is a bottom plan view of the bearing of FIG. 2.

### DETAILED DESCRIPTION OF THE PREFERRED EMBODIMENT

With reference now to the drawings, a preferred embodiment of the curing light with a rotational bearing is herein described. It should be noted that the articles “a,” “an,” and “the,” as used in this specification, include plural referents unless the content clearly dictates otherwise.

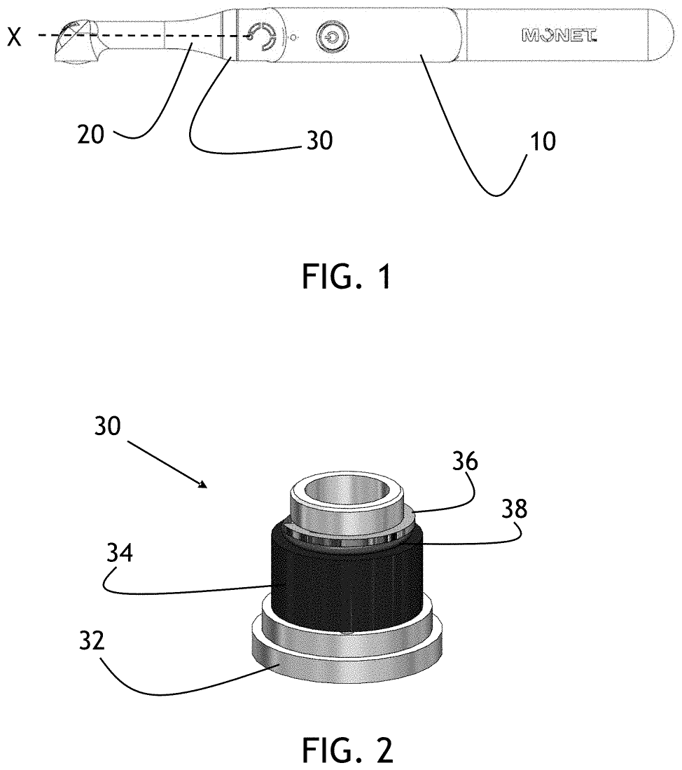

With reference to FIG. 1, a curing light may be constructed with a handpiece 10, a curing light emitter head, 20, and a rotational bearing therebetween 30 serving as the connection between the handpiece 10 and emitter head 20. The handpiece 10 contains any necessary controls (unless controlled at another location such as a foot pedal) and directs light towards the emitter head 20, which contains a waveguide (fiber, lens, mirror, or combination of such parts) within a housing with a connector for attaching the emitter head 20 to the handpiece 10. Light is then directed through the handpiece 10, into the waveguide of the emitter head 20, and out a light exit on the terminal end of the handpiece. Together, the emitter head 20 and handpiece 10 define an axis X. The bearing 30, as one embodiment of the invention, serves as the connection between the emitter head 20 and handpiece 18 and allows full rotation about axis X.

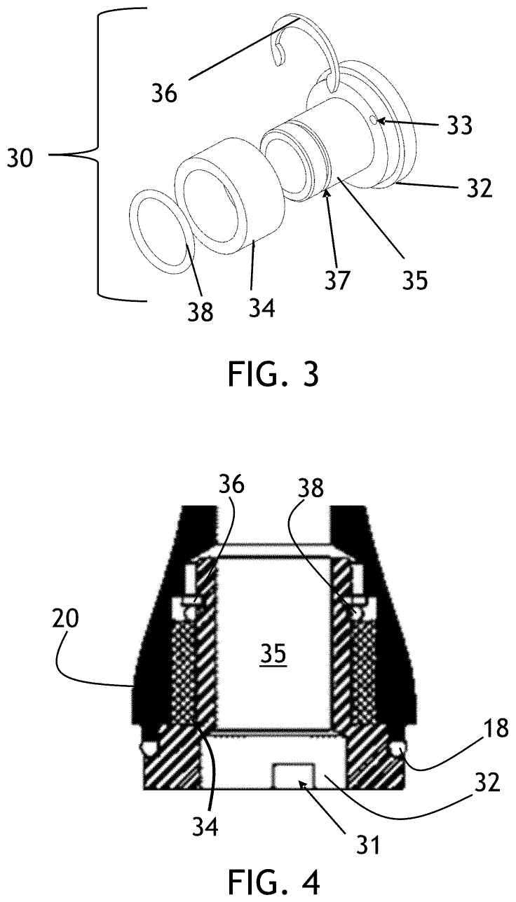

The bearing 30, shown in FIGS. 2 and 3, is a simple structure with a sleeve bearing 34 positioned upon a hollow cylindrical shaft 35 of bearing mount 32, such that it rests on a rim of the bearing mount 32 about the cylindrical shaft 35. A C-clip 36 fits within a groove 37 fashioned in the cylindrical shaft 35 of the bearing mount 32 to secure the sleeve bearing 34 in place. With this configuration, the sleeve bearing 34 may still rotate about the shaft 35 of the bearing mount 32 but is secured against removal. An O-ring 38 may be positioned between the C-clip 36 and upper edge of the sleeve bearing 34 to provide rotational dampening. The sleeve bearing 34 and bearing mount 32 should have as little friction between them as possible to reduce wear and prolong the life of the bearing components. The bearing mount 32 is shown as having a hollow cylindrical shaft 35. This is designed to allow light to pass through the bearing mount from the handpiece 10 to the curing light emitter head 20. This may be accomplished by having transparent intervening light conduit structure, such as a lens, waveguide, or fiber, residing within the hollow defined by the bearing mount 32. It should be understood that either the presence or absence of such structure still yields a “hollow” shaft within the meaning of the term as it is used in this Specification and claims, because such intervening light conduit may be removed and the bearing 30 will still function as basically intended—that the emitter head 20 will rotate about the longitudinal axis X of the handpiece 10 and light will still pass from the handpiece 10, through the bearing 30, and into the emitter head 20.

FIG. 4 shows the connection of the handpiece 20 to the bearing 30. The handpiece housing 20 is press fit onto the sleeve bearing 34 and has little to no contact with any other piece, allowing it to rotate with the sleeve bearing 34 on the bearing mount 32. An additional O-ring 18 may be provided to further control rotation between the emitter head 20 and bearing mount 32 and reduce wear and friction.

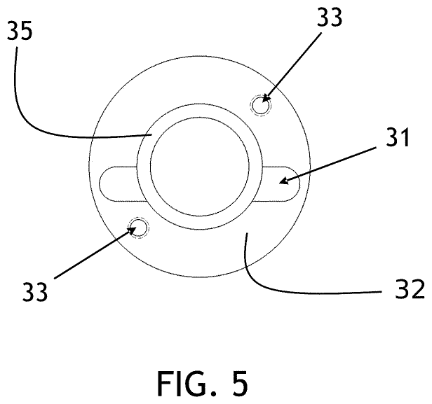

The bearing 30 connects to the handpiece 10 through the rim of its bearing mount 32 (FIG. 5). Mounting holes 33 in the rim, such as the two shown, are a simple manner of effecting the connection to the handpiece through standard bolts. Likewise, a keying interface may be accomplished by providing an asymmetrical slot 31 on the bearing 30 to mate with associated structure on the handpiece 10 (or vice versa). A keying structure would then arrest relative rotation between the bearing 30 and handpiece 10 or any other component of the same in which rotation would be undesirable (such as a waveguide).

Should it become necessary to replace a component of the bearing 30, this design also allows simple disassembly and reassembly with new bearing components. Simple removal of the emitter head 20 from the bearing 30 exposes optional O-ring 18 and the components of the bearing and its connections to the handpiece 10. C-clip 36 may then be removed, allowing for the removal of O-ring 38 and sleeve bearing 34, which in turn allows access to bolts or other structure securing the bearing mount 32 to the handpiece. Components may then be individually cleaned, sterilized, or replaced before reassembly.

Although the present invention has been described with reference to preferred embodiments, numerous modifications and variations can be made and still the result will come within the scope of the invention. The described embodiments are to be considered in all respects only as illustrative and not restrictive. No limitation with respect to the specific embodiments disclosed herein is intended or should be inferred. Therefore, the scope of the invention is indicated by the appended claims rather than by the foregoing description. All changes which come within the meaning and range of equivalency of the claims are to be embraced within their scope, including the manufacturing of the bearing 30 as being a component of the emitter head 20 rather than an attachment to the handpiece 10. It should also be readily understood that which the preferred embodiment is for use in a curing light, the bearing may be utilized in other handpiece contexts where the advantage of 360-degree rotation could be advantageous.

What is claimed is:

1. A bearing for a curing light, said curing light further comprising a handpiece and an emitter head, the bearing comprising:
a bearing mount, said bearing mount further comprising a cylindrical shaft perpendicularly mounted to a base;
a sleeve bearing rotationally fitted onto the cylindrical shaft;
a C-clip securing the sleeve bearing against movement along the cylindrical shaft; and
an O-ring between the C-clip and the sleeve bearing.

2. The bearing for a curing light of claim 1, the bearing being affixed to the handpiece, and the emitter head mounted thereupon.

3. The bearing for a curing light of claim 2, the bearing being affixed to the emitter head and being mountable upon the handpiece.

4. The bearing for a curing light of claim 1, further comprising a second O-ring located on a rim about the cylindrical shaft of the bearing mount, upon which the emitter head will rest when attached to the bearing.

5. The bearing for a curing light of claim 1, further comprising a keying structure in the bearing mount to interface with the handpiece.
